(19) United States
(12) Patent Application Publication
(10) Pub. No.: US 2026/0065496 A1
(43) Pub. Date: Mar. 5, 2026

(54) ELECTRICALLY TUNABLE LENS ASSISTED ABSOLUTE PHASE UNWRAPPING

(71) Applicant: Purdue Research Foundation, West Lafayette, IN (US)

(72) Inventors: Song Zhang, Lafayette, IN (US); Liming Chen, West Lafayette, IN (US)

(21) Appl. No.: 19/314,855

(22) Filed: Aug. 29, 2025

Related U.S. Application Data
(60) Provisional application No. 63/689,610, filed on Aug. 30, 2024.

(51) Int. Cl. G06T 7/571; G02B 21/36

(52) U.S. Cl. CPC G06T 7/571; G02B 21/364; G06T 2200/24; G06T 2207/10028; G06T 2207/10056; G06T 2207/10148; G06T 2207/20212; G06T 2207/30168

(57) ABSTRACT

Described herein are systems and methods for generating three-dimension point clouds. Phase-shifted images of a sample are captured using a camera. Fring contrast maps are generated based on the phase-shifted images. A label map is generated based on the fringe contrast maps. In-focus pixels are extracted from the phase-shifted images to generate a wrapped in-focus phase map. A rough depth map is generated based on the label map. An artificial phase map is generated based on the rough depth map. The wrapped in-focus phase map is unwrapped and a three-dimensional point cloud is generated based on the unwrapped in-focus phase map.

### CROSS-REFERENCE TO RELATED APPLICATIONS

This application claims priority to U.S. Application No. 63/689,610, filed Aug. 30, 2024, which is hereby incorporated by reference in its entirety.

### STATEMENT REGARDING FEDERALLY SPONSORED RESEARCH

This invention was made with government support under U.S. Pat. No. 1,763,689 awarded by the National Science Foundation. The government has certain rights in the invention.

### BACKGROUND

Microscopic structured-light (MSL) or microscopic fringe projection three-dimensional (3D) imaging is an inspection and measurement technique used in many industries that require high-precision 3D data acquisition for miniaturized objects, such as additive manufacturing, micro-electronics, and micro-mechatronics.

### SUMMARY

In some aspects, the present disclosure can provide a three-dimensional imaging microscope system. The system can include a projector, a camera, and an electrically tunable lens (ETL). A processor coupled to the projector, the camera, and the ETL can be configured to capture, using the camera, a plurality of phase-shifted images of a sample by controlling the projector, the camera, and the ETL. A plurality of fringe contrast maps can be generated based on the plurality of phase-shifted images. Each fringe contrast map of the plurality of fringe contrast maps can correspond to a respective focus setting of a plurality of focus settings of the ETL. A label map can be generated based on the plurality of fringe contrast maps. A plurality of in-focus pixels can be extracted from the plurality of phase-shifted images to generate a wrapped in-focus phase map. A rough depth map can be generated based on the label map. The rough depth map can indicate an estimated depth for each pixel of the plurality of in-focus pixels. An artificial phase map can be generated based on the rough depth map. The wrapped in-focus phase map can be unwrapped to generate an unwrapped in-focus phase map. A three-dimensional point cloud can be generated based on the unwrapped in-focus phase map.

In further aspects, the present disclosure can provide a method for generating a three-dimensional point cloud. A plurality of phase-shifted images of a sample can be captured by a camera by controlling a projector, a camera, and an electrically tunable lens (ETL) via a processor. A plurality of fringe contrast maps can be generated based on the plurality of phase-shifted images. Each fringe contrast map of the plurality of fringe contrast maps can correspond to a respective focus setting of a plurality of focus settings of the ETL. A label map can be generated based on the plurality of fringe contrast maps. A plurality of in-focus pixels can be extracted from the plurality of phase-shifted images to generate a wrapped in-focus phase map. A rough depth map indicating an estimated depth for each pixel of the plurality of in-focus pixels can be generated based on the label map. An artificial phase map can be generated based on the rough depth map. The wrapped in-focus phase map can be unwrapped to generate an unwrapped in-focus phase map. A three-dimensional point cloud based can be generated on the unwrapped in-focus phase map.

In further aspects, the present disclosure can provide a non-transitory computer readable medium storing instructions that, when executed, can cause a processor to capture, using a camera, a plurality of phase-shifted images of a sample by controlling a projector, a camera, and an electrically tunable lens (ETL) via a processor. A plurality of fringe contrast maps can be generated based on the plurality of phase-shifted images. Each fringe contrast map of the plurality of fringe contrast maps can correspond to respective focus setting of a plurality of focus settings of the ETL. A label map can be generated based on the plurality of fringe contrast maps. A plurality of in-focus pixels can be extracted from the plurality of phase-shifted images to generate a wrapped in-focus phase map. A rough depth map indicating an estimated depth for each pixel of the plurality of in-focus pixels can be generated based on the label map. An artificial phase map can be generated based on the rough depth map. The wrapped in-focus phase map can be unwrapped to generate an unwrapped in-focus phase map. A three-dimensional point cloud can be generated based on the unwrapped in-focus phase map.

### BRIEF DESCRIPTION OF THE DRAWINGS

The foregoing features of embodiments will be more readily understood by reference to the following detailed description, taken with reference to the accompanying drawings, in which:

FIG. 1 is a block diagram conceptually illustrating an example three-dimensional vision system for analyzing an object according to some embodiments.

FIG. 2 is a flow diagram illustrating an example process for generating a three-dimensional point cloud based according to some embodiments.

FIGS. 3A-3F illustrate examples of captured fringe images and the corresponding focus measurements according to some embodiments.

FIGS. 4A-4D illustrates example results of a focal plane calibration and estimated depth map according to some embodiments.

FIG. 5 is a schematic diagram of a multi-focus microscopic structured-light (MSL) system according to some embodiments.

FIG. 6 is an example workflow for three-dimensional point cloud estimation according to some embodiments.

FIGS. 7A and 7B illustrate an example prototype system according to some embodiments.

FIGS. 8A-8L illustrate experimental results for a three-dimensional printed sample according to some embodiments.

FIGS. 9A-9E illustrate a creation of an unwrapped phase for each example shown in FIGS. 7A-7L according to some embodiments.

FIGS. 10A-10D illustrate three-dimensional reconstruction of a corresponding unwrapped phase map shown in FIG. 8E according to some embodiments.

FIGS. 11A-11C illustrate experimental results of measuring two isolated samples placed at different depths according to some embodiments.

FIGS. 12A-12D illustrate a comparison between methods and three-dimensional phase unwrapping algorithms according to some embodiments.

### DETAILED DESCRIPTION

Microscopic structured-light (MSL) or microscopic fringe projection three-dimensional (3D) imaging is an inspection and measurement technique used in many industries that require high-precision 3D data acquisition for miniaturized objects, such as additive manufacturing, micro-electronics, and micro-mechatronics. Despite recent rapid advancements in this technological area, a shallow depth of field (DOF) is still a major limitation in many applications of such 3D imaging.

A focus stacking technique can be used to achieve a larger DOF in microscopic 3D imaging with high spatial resolution. In focus stacking, a series of images taken at different focus settings (e.g., focal length, image distance, or object distance), which is referred to as focal stack, are combined into an all-in-focus image. However, a drawback of such a technique is its reliance on multiple images, which results in a slower imaging speed. This issue can be even more severe in MSL 3D imaging because, unlike 2D imaging, multiple fringe images may be required under each single focus setting to recover a 3D point cloud. Reducing the number of required fringe patterns (or pattern orientations) is important for the efficiency of large DOF MSL 3D imaging systems with the focus stacking technique.

MSL systems may implement phase unwrapping to recover phase information from fringe images. Phase unwrapping enables elimination of 27 discontinuities that may be present in fringe images. In some examples, phase unwrapping algorithms can be broadly categorized into two groups: spatial phase unwrapping algorithms and temporal phase unwrapping algorithms. The spatial phase unwrapping algorithms detect and remove 2π discontinuities by analyzing a wrapped phase map itself, such as in quality-guided methods and multi-anchor unwrapping methods. Though spatial phase unwrapping algorithms may require no additional patterns, processing isolated objects may present a challenge. Moreover, spatial phase unwrapping algorithms, in some examples, can yield a relative unwrapped phase map, as the unwrapping process is based on a chosen starting point within the wrapped phase map. On the other hand, the temporal phase unwrapping algorithms fundamentally eliminate the 2π discontinuities by acquiring more information from additional images.

In some examples, other phase unwrapping methods may use fewer or no additional images. For example, deep learning methods have been introduced into structured-light systems to solve phase unwrapping problems. However, these methods may require a large training dataset, which can be difficult to acquire.

In a geometric-constraint phase unwrapping (GCPU) algorithm, an artificial phase map is created given a calibrated system and an estimated depth value. A wrapped phase map can then be unwrapped using an artificial phase map pixel-by-pixel. This technique may be advantageous in high-speed 3D imaging, for example. However, GCPU algorithms may have limitations. First, an approximate depth of the measured objects is used. Second, a single estimated depth value may work within a limited depth range.

In some examples, the systems and methods described herein may use an absolute phase unwrapping method that can address the limitations of GCPU algorithms in large DOF microscopic structured-light 3D imaging systems without requiring additional patterns. For example, in the systems and methods described herein, the depth value of each in-focus pixel from the focal plane position of the electrically tunable lens may be estimated. The estimated focal plane position information may further be used to unwrap the in-focus phase pixel-by-pixel using the geometric-constraint-based phase unwrapping algorithm.

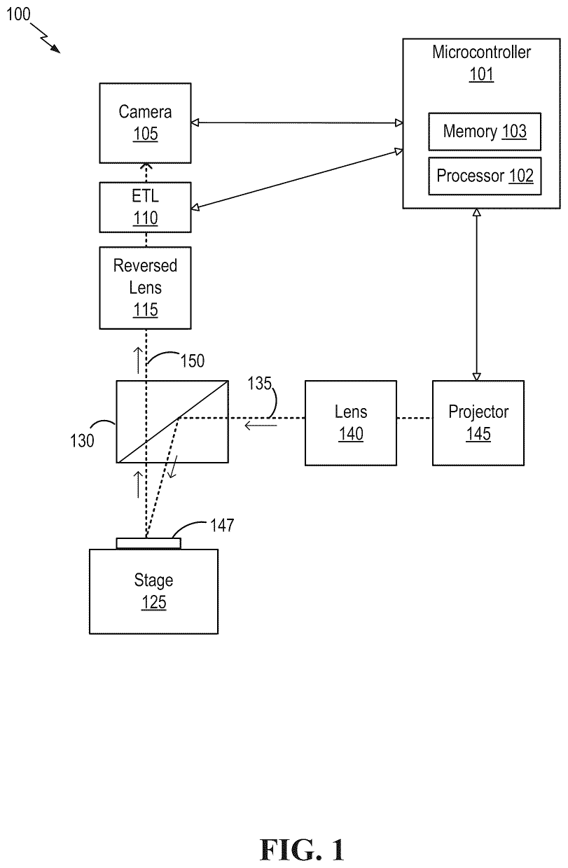

FIG. 1 shows a block diagram illustrating a system 100 for analyzing an object according to some embodiments. The system 100 can include a microcontroller 101 having a processor 102 and a memory 103, a camera 105, an electronically controllable lens (ETL) 110, a reversed lens 115, a stage 125, a beam splitter 130, a lens 140, and a projector 145.

The microcontroller 101 may be communicatively coupled to and may control the projector 145, the ETL 110, and the camera 105 to capture images of a sample 147 positioned on the stage 125. Generally, in operation, the microcontroller 101 may control the projector 145 to emit a light beam pattern 135 (referred to as a pattern 135) towards the lens 140 (e.g., a pin hole lens). For example, the microcontroller 101 may control the projector 145 to project patterns onto the stage 125 at various phase-angles, where the pattern at each phase-angle may be referred to as a separate instance of the pattern 135. The lens 140 may be configured to focus the pattern 135 on the stage 125 (or the sample 147 thereon). The beam splitter 130 may reflect the pattern 135 (also referred to as a focused pattern at this stage) received from the lens 140, towards the stage 125 and the sample 147. The pattern 135 may be received by the sample 147 and then reflect, refract, emit, or otherwise travel away from the sample 147 and the stage 125, through the beam splitter 130, and towards the reversed lens 115. This beam travelling away from the sample 147 and the stage 125 may be referred to as a reflected pattern 150. The reflected pattern 150 may be received by the reversed lens 115 and focused by the reversed lens 115. After transiting through the reversed lens 115, the reflected pattern 150 may be focused by the ETL 110 on the camera 105 (e.g., on a detector array of the camera 105). The microcontroller 101 may drive the ETL 110 with a current that varies a focus (or focal point) of the ETL 110 and controls the camera to capture an image of the reflected pattern 150 and, thus, of the sample 147. For example, the focus of the ETL 110 may vary depending on an amplitude of the current. Thus, by changing the current to the ETL 110, the microcontroller 101 may cause the camera 105 to capture phase-shifted images of the sample 147 at different focus settings. The phase-shifted images may be referred to as a focal stack of images or focal stack images. The camera 105 may output, and the microcontroller 101 may receive, the images captured by the camera 105, including the focal stack images.

The processor 102 can be a hardware processor or combination of processors, such as a central processing unit (CPU), a graphics processing unit (GPU), an accelerated processing unit (APU), an application specific integrated circuit (ASIC), a field-programmable gate array (FPGA), a digital signal processor (DSP), or the like.

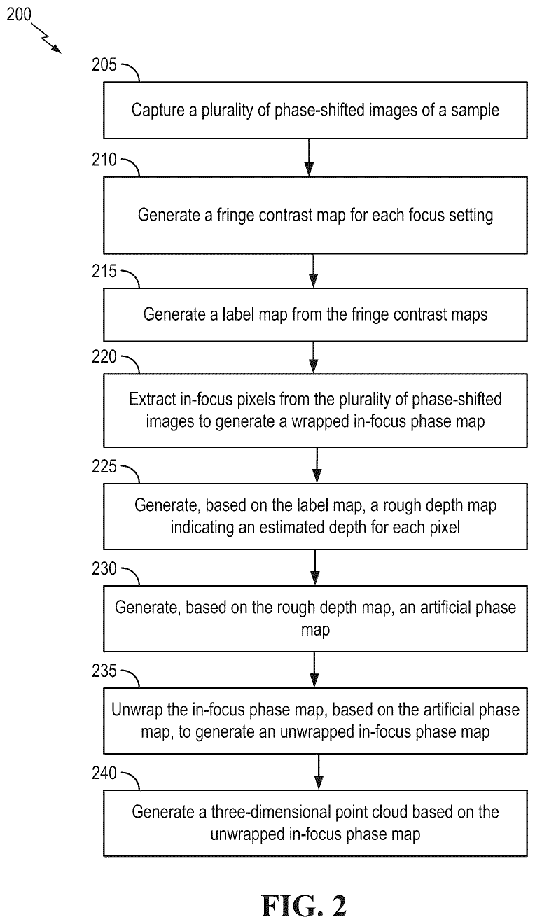

The memory 103 can include a non-transitory computer-readable medium including volatile memory, non-volatile memory, or a combination thereof. For example, memory 103 can include random access memory (RAM), read-only memory (ROM), electronically-erasable programmable read-only memory (EEPROM), a flash drive, a hard disk, a solid state drives, an optical drive, combinations thereof, or the like. The memory 103 can include a storage device or devices that can be used to store data and instructions that can be used by the processor 102. For example, the memory 103 can include instructions that, when executed, cause the processor 102 to perform the process 200 described with respect to FIG. 2, or at least a portion thereof, to generate a three-dimensional point cloud. In some embodiments, the processor 102 can execute instructions stored on the memory 103 to perform at least a portion of process 200 described below in connection with FIG. 2. In some examples, the memory 103 may store one or more images or phase-shifted images (also referred to as fringe images) captured by the camera 105. In some examples, the memory 103 may store one or more of phase images, fringe contrast maps, label maps, rough depth maps, wrapped all-in-focus phase maps, artificial phase maps, unwrapped all-in-focus phase maps, calibrated models, and/or three-dimensional point clouds generated and/or used by the processor 102 in the various techniques described herein.

FIG. 2 is a flow diagram illustrating an example three-dimensional point cloud generation process 200. As described below, a particular implementation can omit some or all illustrated features/steps, may be implemented in some embodiments in a different order, and may not require some illustrated features to implement all embodiments. In some examples, the system 100 can be used to perform all or part of the process 200. However, other suitable processing hardware for carrying out the operations or features described below may perform the process 200.

At block 205, a processor (e.g., processor 102) causes a camera (e.g., camera 105) to capture a plurality of phase-shifted images of a sample by controlling a projector (e.g., projector 145), the camera, and an ETL (e.g., ETL 110). In some examples, each of the plurality of phase-shifted images may correspond to a reflection (e.g., reflected pattern 150) of a pattern (e.g., pattern 135) projected onto a sample (e.g., sample 147) located on a stage (e.g., stage 125) by the projector.

For example, the processor 102 may control the ETL 110 to cycle through a plurality of focus settings (e.g., by driving the ETL 110 with current at a different level for each setting). At each focus setting of the ETL 110, the processor 102 may control the projector 145 to emit a pattern at a plurality of phases, and may control the camera 105 to capture an image of the reflected pattern at each of the phases. Thus, for example, when capturing images by applying N different focus settings and projecting a pattern at M different phases (with N and M being positive integers), the processor 102 may generate N×M phase-shifted images of the sample. In some examples, only one pattern orientation may be measured to capture N×M images used for three-dimensional reconstruction. For example, with four different focus settings and three different phases, the processor may capture twelve phase-shifted images of the sample (e.g., image₁ at focus setting 1 (f₁), phase 1 (φ₁); image₂ at f₁, φ₂; image₃ at f₁, φ₃; image₄ at f₂, φ₁; images at f₂, φ₂; image₆ at f₂, φ₃; image₇ at f₃, φ₁; images at f₃, φ₂; image₉ at f₃, φ₃; image₁₀ at f₄, φ₁; image₁₁ at f₄, φ₂; and image₁₂ at f₄, φ₃). The particular number of focus settings and phase numbers varies in other examples. Additionally, although the present techniques enable 3D reconstruction with one pattern orientation (e.g., shortening the overall capture time), in some examples, multiple pattern orientations can be used. In such cases, the processor 102 may generate N×M phase-shifted images of the sample for each pattern orientation.

In some examples, the processor 102 may further apply a phase-shifting algorithm to the captured plurality of phase-shifted images to generate phase images, also referred to as wrapped phase maps. Each phase image may correspond to one of the focus settings used to capture the plurality of phase-shifted images. Thus, the images captured at different phases for a particular focus setting may be combined into a phase image by applying the phase-shifting algorithm. For the phase-shifting algorithm, in a structured light (SL) system, the k^{th} fringe image captured by the camera can be mathematically represented as

$${I}_{k} ( {u}^{c} , {v}^{c} ) = {I}^{′} ( {u}^{c} , {v}^{c} ) + {I}^{″} ( {u}^{c} , {v}^{c} ) cos [ ϕ ( {u}^{c} , {v}^{c} ) + \frac{2 k π}{N} ] ,$$

where I′(u^{c}, v^{c}) represents the ambient light intensity, I″(u^{c}, v^{c}) represents the fringe modulation, φ(u^{c}, v^{c}) represents the phase of the projected signal, and N denotes the total number of the phase-shifted fringe patterns. When N≥3, the phase of each pixel can be uniquely determined as

$$ϕ ( {u}^{c} , {v}^{c} ) = - arctan \frac{{\sum }_{k = 1}^{N} {I}_{k} ( {u}^{c} , {v}^{c} ) sin ( \frac{2 k π}{N} )}{{\sum }_{k = 1}^{N} {I}_{k} ( {u}^{c} , {v}^{c} ) cos ( \frac{2 k π}{N} )} .$$

In some examples, the phase determined for each pixel by the above equation may have 2w discontinuities due to the properties of the arctangent function. Hence, a phase unwrapping algorithm may be used to recover a continuous phase map, which is referred to as an unwrapped phase map, as Φ(u^{c}, v^{c})=φ(u^{c}, v^{c})+2πK(u^{c}, v^{c}), where the fringe order K(u^{c}, v^{c}) is an integer number obtained from the phase unwrapping algorithm. The phase unwrapping algorithm is discussed further below.

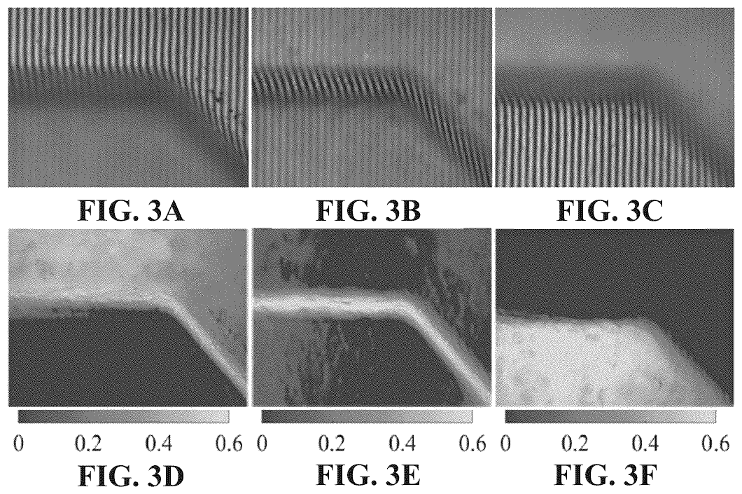

FIGS. 3A-3C illustrate, respectively, three fringe images, where FIG. 3A corresponds to a captured image for a first pattern and first focus setting, FIG. 3B corresponds to a captured image for the first pattern and a second focus setting, and FIG. 3C corresponds to a captured image for the first pattern and a third focus setting. In this particular example, ETL current for the ETL 110 was set as −140.00 mA, −131.00 mA, and −116.00 mA to capture the fringe images of FIGS. 3A, 3B, and 3C, respectively.

At block 210, the processor generates a plurality of fringe contrast maps corresponding to the plurality of phase-shifted images. For example, the processor 102 may generate a fringe contrast map for each phase image. Thus, in some examples, the processor 102 may generate a fringe contrast map for each focus setting of the captured plurality of phase-shifted images. A fringe contrast map for a phase image may include a contrast level for each pixel of the phase image (e.g., indicating a quantity of a phase of a pixel relative to its neighbor pixels). Thus, the fringe contrast map may indicate pixel-wise fringe contrast. Further, such fringe contrast may be used as a measure of focus for a pixel. For example, a higher contrast level for a pixel in a first phase image relative to the same pixel in a second phase image (i.e., a pixel at the same position within the two phase images) may indicate that the pixel in the first phase image is more in focus than the same pixel in the second phase image.

The fringe contrast may be defined as

$$γ ( {u}^{c} , {v}^{c} ) = \frac{{I}^{″} ( {u}^{c} , {v}^{c} )}{{I}^{′} ( {u}^{c} , {v}^{c} )} ,$$

where the I″(u^{c}, v^{c}) and the I′(u^{c}, v^{c}) can also be determined:

$$\begin{matrix}{I}^{′} ( {u}^{c} , {v}^{c} ) = \frac{1}{N} {\sum }_{k = 1}^{N} {I}_{k} ( {u}^{c} , {v}^{c} ) , and \\ {I}^{″} = \frac{2}{N} \sqrt{{[ {\sum }_{k = 1}^{N} {I}_{k} cos ( \frac{2 k π}{N} ) ]}^{2} + {[ {\sum }_{k = 1}^{N} {I}_{k} sin ( \frac{2 k π}{N} ) ]}^{2}} ,\end{matrix}$$

where (u^{c}, v^{c}) is omitted after the symbol I″ and Iₖ for simplicity.

FIGS. 3D-3F illustrate, respectively, fringe contrast maps corresponding to FIGS. 3A-3C. A comparison of the example fringe images shown in FIGS. 3A-3C and the corresponding fringe contrast maps shown in FIGS. 3D-3F shows that the fringe contrast is high in the in-focus regions.

At block 215, the processor generates a label map from the fringe contrast maps generated at block 210. For example, with the focus measure provided by the fringe contrast maps, the processor 102 may create the label map l(u, v). The label map l(u, v) may store an index of the ETL current (e.g., 0 demonstrates the first used ETL current, 1 demonstrates the second used ETL current, etc.), that produces enhanced focus, within the used ETL currents for each pixel. The index of the ETL current may also represent a focus setting, because ETL current corresponds to the focus setting of the ETL. For example, an index of 0 may indicate a first focus setting, an index of 1 may indicate a second focus setting, etc. Further, the index of the ETL current may also represent a particular wrapped phase map (or phase image) of the generated wrapped phase maps, because each wrapped phase map may correspond to a focus setting and, thus, an ETL current. For example, an index of 0 may indicate a first wrapped phase map, an index of 1 may indicate a second wrapped phase map, etc. Further, the index of the ETL current may also represent a particular fringe contrast map of the plurality of fringe contrast maps, because each fringe contrast map may correspond to wrapped phase map and a focus setting and, thus, an ETL current. For example, an index of 0 may indicate a first fringe contrast map, an index of 1 may indicate a second fringe contrast map, etc.

In some examples, the processor 102 may search for the maximum focus measure (e.g., contrast level) within the focal stack (e.g., within the fringe contrast maps) for each pixel. Thus, for each pixel, the processor 102 may identify a fringe contrast map that has the corresponding maximum contrast level for that pixel. The index in the label map for that pixel may then have a value that corresponds to the identified fringe contrast map (and/or the associated wrapped phase map, focus setting, and/or ETL current). Thus, each pixel of the label map may index or point to a pixel of a particular a wrapped phase map.

However, in some examples, the fringe contrast may be affected by a surface texture of the sample 147, especially in dark regions. Therefore, in some examples, the processor can further optimize the label map using an energy minimization algorithm that minimizes:

$$E ( l ) = {\sum }_{p ∈ V} E ( {l}_{p} ) + λ {\sum }_{( p , q ) ∈ 𝒞} {E}_{p , q} ( {l}_{p} , {l}_{q} ) , \qquad ( 1 )$$

where the p represents a pixel in the set V composed of all camera pixels. In some examples, the processor 102 may solve this equation (1) via an a-expansion algorithm to provide the label map. The first term on the right-hand side represents the blur level of the pixel p under the lₚ-th focus setting among the focal stack, which can be mathematically described as E(lₚ)=exp{−γ(p; lₚ)}, where γ(p; lₚ) is the fringe contrast that can be obtained from the above equations. Meanwhile, the second term is a regularizer to constrain a smoothness of the label map. The processor 102 may further adopt a total variation (TV) operator, which can be mathematically described as E(lₚ, l_{q})=|lₚ−l_{q}|, where q is a neighboring pixel of p defined by four-connected grid [symbol] , and λ is a weight to balance the contribution of the two terms.

At block 220, the processor extracts in-focus pixels from the plurality of phase-shifted images to generate a wrapped in-focus phase map. For example, the label map may indicate which pixels within each phase image are in-focus (e.g., based on contrast levels, as explained above). Accordingly, the processor 102 may access the label map to identify the in-focus pixels of the phase images to be extracted, and may then extract those identified in-focus pixels. The processor 102 may then combine, or stitch together, the various in-focus pixels extracted to form the wrapped in-focus phase map. For example, each pixel of the wrapped in-focus phase map may be the pixel from the phase images having the highest contrast level at that pixel location. Accordingly, the resulting wrapped in-focus phase map may have the most in-focus pixel (or deemed to be the most in-focus pixel based on the label map) available for each pixel location of the wrapped in-focus phase map.

At block 225, the processor generates a rough depth map, based on the label map. In some examples, the rough depth map indicates an estimated depth for each pixel. For example, after extracting an in-focus pixel, the processor 102 can approximate a depth as the focal plane position under the corresponding focus setting. This approximation can be done through a calibration process. Since an ETL (e.g., ETL 110) is used to adjust focal planes, the relationship between the focal plane positions and the ETL driving currents is calibrated. The calibration is conducted using a flat plane with some surface textures (e.g., as the sample 147) and a vertical translation stage. Specifically, the flat plane is positioned roughly perpendicular to the z axis of the world coordinate system at several distances within the desired DOF, and then the processor 102 captures images with the camera 105 for each z-axis position using multiple ETL currents (or focus settings). The processor 102 may then compute a blur metric for each captured image, and fit a Gaussian model,

$$( i ) = {\sum }_{j = 1}^{n} {a}_{j} exp \{ - \frac{( i - {μ}_{j} )}{{σ}_{j}} \} ,$$

where [symbol] (i) represents the blur level of the image under ETL driving current i, and aⱼ, μⱼ, σⱼ are constant parameters in the Gaussian model. In some examples, two-term Gaussian models are fitted (i.e., n=2).

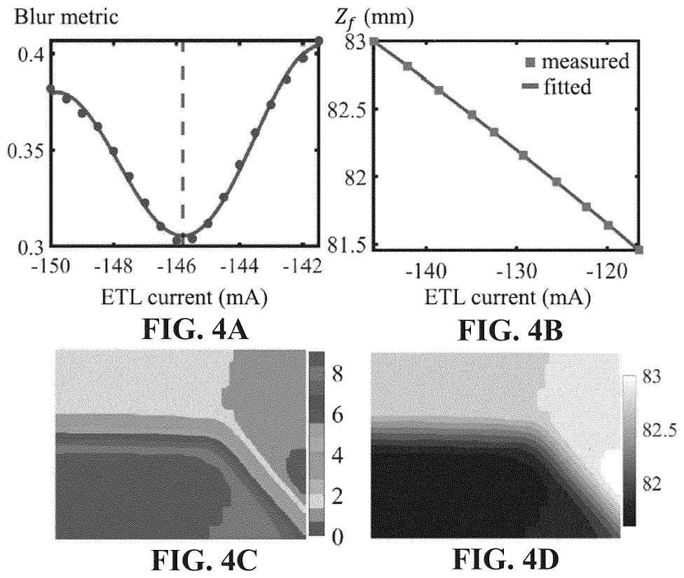

FIG. 4A shows an example of a fitted Gaussian model. With the Gaussian model, a set ETL current can be obtained that produces a minimum blur level. For each plane position, phase-shifted patterns are also projected with three frequencies while setting the ETL current as the set ETL current, and then reconstructing the 3D shape of the plane from the unwrapped phase map using the calibration data with the ETL current setting. In some examples, the world coordinate system may be aligned with the camera coordinate system during the calibration and the plane may be roughly perpendicular to the z-axis, the average depth (z value) of the reconstructed plane may be approximated as the focal plane position. Then, a third-order polynomial function may be fitted using the focal plane positions and the set ETL currents may be:

$${z}_{f} ( i ) = {\sum }_{n = 0}^{3} {c}_{n} {i}^{n} , \qquad ( 2 )$$

where z_{f}(i) represents the focal plane position under the ETL current i, and c, represents the polynomial coefficients. FIG. 4B shows calibrated results from an example.

Once the focal plane positions are calibrated, the depth zₘᵢₙ(i) can be computed by substituting the ETL currents indicated by the label map into the above equation (2), as the example shown in FIG. 4D. More particularly, FIG. 4C illustrates a label map (e.g., with each pixel at its most enhanced focus), which may be obtained by solving equation (1) using α-expansion algorithm. FIG. 4D illustrates an estimated depth map generated by the label map in FIG. 4C using calibrated results shown in FIG. 4B.

At block 230, the processor generates, based on the rough depth map, an artificial phase map. In some examples, various intrinsic and extrinsic matrices corresponding to different focus settings (e.g., calibration data for the system 100, as described further below) are used to create the artificial phase map. Specifically, in some examples, the processor 102 may calculate the world coordinates (x^{w}, y^{w}) for camera pixel (u^{c}, v^{c}), using the estimated depth values zₘᵢₙ(i), by,

$$[ \begin{matrix}{x}^{w} \\ {y}^{w}\end{matrix} ] = {M}^{- 1} b ,$$

where

$$M = [ \begin{matrix}{p}_{31}^{c} {u}^{c} - {p}_{11}^{c} & {p}_{32}^{c} {u}^{c} - {p}_{12}^{c} \\ {p}_{31}^{c} {u}^{c} - {p}_{21}^{c} & {p}_{32}^{c} {u}^{c} - {p}_{22}^{c}\end{matrix} ] ,$$

and

$$b = [ \begin{matrix}{p}_{14}^{c} - {p}_{34}^{c} {u}^{c} - ( {p}_{33}^{c} {u}^{c} - {p}_{13}^{c} ) {z}_{min} ( i ) \\ {p}_{24}^{c} - {p}_{34}^{c} {u}^{c} - ( {p}_{33}^{c} {u}^{c} - {p}_{23}^{c} ) {z}_{min} ( i )\end{matrix} ] ,$$

where

$${p}_{mn}^{c}$$

represents the item of P^{c}(i) in m-th row and n-th column. (x^{w}, y^{w}) and zₘᵢₙ(i) are then substituted to compute the corresponding projector point

$$( {u}^{p} , {v}^{p} ) as , {s}^{p} [ \begin{matrix}{u}^{p} \\ {v}^{p} \\ 1\end{matrix} ] = {P}^{p} [ \begin{matrix}{x}^{w} \\ {y}^{w} \\ {z}_{min} ( i ) \\ 1\end{matrix} ] .$$

The processor 102 may calculate the artificial phase map Φₘᵢₙ(u^{c}, v^{c}) by substituting the solved u^{p} as,

$${Φ}_{min} ( {u}^{c} , {v}^{c} ) = \frac{2 π {u}^{p}}{T} .$$

Finally, the processor may determine fringe order using the artificial phase map as

$$κ ( {u}^{c} , {v}^{c} ) = round [ \frac{{Φ}_{min} ( {u}^{c} , {v}^{c} ) - ϕ ( {u}^{c} , {v}^{c} )}{2 π} ] ,$$

where φ(u, v) is the wrapped phase map.

At block 235, the processor unwraps the in-focus phase map, based on the artificial phase map, to generate an unwrapped in-focus phase map. For example, the processor 102 may implement the geometric-constraint phase unwrapping (GCPU) algorithm to unwrap the in-focus phase map using the artificial phase map, pixel-by-pixel. As a result of the unwrapping, the processor 102 may assign each pixel an absolute phase that is valid within the projector's space. That is, the unwrapping can correct 2π discontinuities that may exist in the in-focus phase map. For example, to execute the GCPU algorithm, the processor may compare, pixel-by-pixel, each pixel of the in-focus phase map to its corresponding pixel of the artificial phase map. As a result of the comparison, the processor may add zero, one, or more 2π periods to provide the absolute phase for the corresponding pixel in the unwrapped in-focus phase map.

At block 240, the processor generates a three-dimensional (3D) point cloud based on the unwrapped, in-focus phase map. For example, the processor 102 may reconstruct a 3D point cloud from the unwrapped, in-focus phase map based on calibration data for the system 100. The calibration data may include functions and parameters of a multi-focus pin-hole model for the system, as described further below. With the calibration data known, the processor 102 can reconstruct a 3D point cloud under any focus setting within the calibrated range using, for example, the equations 3, 4, and 5, described below.

For example, after obtaining the unwrapped phase map, the coordinate u^{p} of the corresponding projector point for camera pixel (u^{c}, v^{c}) can be calculated when the vertical fringe patterns are applied as, u^{p}=Φ(u^{c}, v^{c})×T/2π, where T represents the fringe period. The other coordinate v^{p} can be calculated in a similar manner when the horizontal fringe patterns are applied.

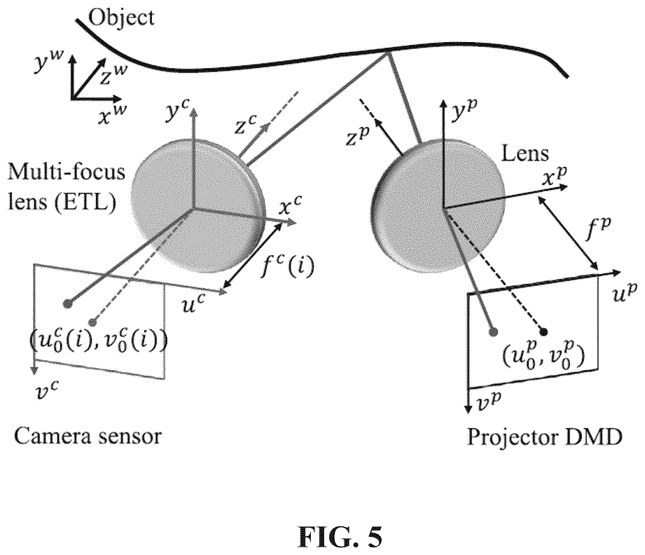

FIG. 5 shows a schematic diagram of a large DOF MSL system, such as the system 100, that may implement a focus stacking technique. A camera (e.g., the camera 105) captures fringe images under various focus settings realized by a multi-focus lens (e.g., an ETL) attached to the camera. As described herein, an ETL (e.g., ETL 110) can be used to adjust the focal length of a pin-hole lens by modifying the driving current provided to the ETL. Meanwhile, another pin-hole lens (e.g., the lens 140) is attached to the projector (e.g., the projector 145). The multi-focus pin-hole model may be described as:

$${s}^{c} [ \begin{matrix}{u}^{c} \\ {v}^{c} \\ 1\end{matrix} ] = {\underbrace{[ \begin{matrix}{f}_{u}^{c} ( i ) & 0 & {u}_{0}^{c} ( i ) \\ 0 & {f}_{v}^{c} ( i ) & {v}_{0}^{c} ( i ) \\ 0 & 0 & 1\end{matrix} ] [ \begin{matrix}{R}^{c} ( i ) & {T}^{c} ( i )\end{matrix} ]}}_{{P}^{c} ( i )} [ \begin{matrix}{x}^{w} \\ {y}^{w} \\ {z}^{w} \\ 1\end{matrix} ] , \qquad ( 3 )$$

and the projector with the constant pin-hole model as:

$${s}^{p} [ \begin{matrix}{u}^{p} \\ {v}^{p} \\ 1\end{matrix} ] = {\underbrace{[ \begin{matrix}{f}_{u}^{p} & 0 & {u}_{0}^{p} \\ 0 & {f}_{v}^{p} & {v}_{0}^{p} \\ 0 & 0 & 1\end{matrix} ] [ \begin{matrix}{R}^{p} & {T}^{p}\end{matrix} ]}}_{{P}^{p}} [ \begin{matrix}{x}^{w} \\ {y}^{w} \\ {z}^{w} \\ 1\end{matrix} ] , \qquad ( 4 )$$

where s^{c} and s^{p} are scaling factors, (u^{c}, v^{c}) and (u^{p}, v^{p}) are the projected 2D coordinates of the 3D points (x^{w}, y^{w}, z^{w}) on the camera and projector sensor planes, respectively. The

$${f}_{u}^{c} ( i ) , {f}_{v}^{c} ( i ) , {u}_{0}^{c} ( i ) and {v}_{0}^{c} ( i )$$

are polynomial functions of the ETL current i that form the camera intrinsic matrix. Similarly, the rotation matrix R^{c}(i) and the translation vector T^{c}(i) are also polynomial functions that form the camera extrinsic matrix. On the other hand, the

$${f}_{u}^{p} , {f}_{v}^{p} , {u}_{0}^{p} and {v}_{0}^{p}$$

are constant parameters that form the projector intrinsic matrix. The R^{p} and T^{p} are constant rotation and translation matrices for the projector.

The first-order camera lens radial distortion may be considered as:

$$[ \begin{matrix}{u}_{d} \\ {v}_{d}\end{matrix} ] = ( 1 + {k}_{1} ( i ) {r}^{2} ) [ \begin{matrix}\overline{u} \\ \overline{v}\end{matrix} ] , \qquad ( 5 )$$

where

$$r = \sqrt{{\overline{u}}^{2} + {\overline{v}}^{2}} .$$

The [u_{d}, v_{d}]^{T} are the distorted normalized image coordinates and [ū, v̅]^{T} are the ideal (distortion-free) normalized image coordinates. The k₁(i) denotes the radial distortion coefficients.

To calibrate the model for the system 100, virtual features may be employed. This calibrated model may then be used for 3D reconstruction (e.g., in block 240). Specifically, a corresponding projector point for each camera pixel is found after rectifying the camera lens distortions following Eq. (5). Given the calibrated intrinsic and extrinsic matrices, a 3D point in the world coordinate system can be uniquely determined since there are five unknowns (i.e., s^{c}, s^{p}, x^{w}, y^{w}, z^{w}) and six equations. To avoid redundancy, one coordinate (i.e., u^{p} or v^{p}) is typically used for each corresponding projector point. The corresponding pairs between camera pixels and projector points can be reliably established by phase information of the projected fringe patterns. Further, because the world coordinate systems under different focus settings have been aligned by this calibration, a 3D point cloud with a large DOF can be reconstructed using focused pixels under all focus settings and the corresponding intrinsic and extrinsic matrices. The calibrated model (e.g., the calibrated multi-focus pin-hole model) may be the calibration data, or a portion thereof.

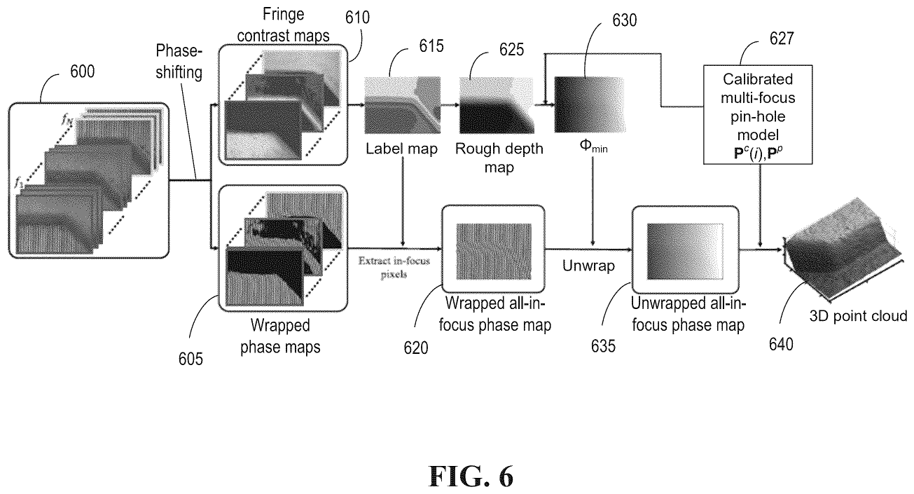

A diagram of an example procedure to generate a 3D point cloud using the process 200 of FIG. 2 is illustrated in FIG. 6. More particularly, three sets of phase-shifted fringe images 600 are captured under N focus settings as an example of a plurality of phase-shifted images (e.g., as described with respect to block 205). Then, the phase-shifting algorithm described herein is performed under each focus setting to generate the corresponding wrapped phase maps 605 (e.g., as described with respect to block 205) and fringe contrast maps 610 (e.g., as described with respect to block 210). A label map 615 is generated from the fringe contrast maps 610 (e.g., as described with respect to block 215). The label map 615 is used to extract in-focus pixels under different focus settings from the wrapped phase maps 605. The extracted in-focus pixels are combined to generate the wrapped all-in-focus phase map 620 (e.g., as described with respect to block 220). Furthermore, depth values are approximated from the label map 615 to generate a rough depth map 625 (based on calibrated data 627 for the system), where the depth values of the rough depth map 625 are for each in-focus pixel as the focal plane positions of the corresponding focus setting (e.g., as described with respect to block 225). The calibration data may include a calibrated multi-focus pin-hole model as described above. The depth map may be used to generate an artificial phase map 630 (e.g., as described with respect to block 230). The wrapped all-in-focus phase map 620 may be unwrapped by a GCPU algorithm given the focal plane positions using the artificial phase map 630, resulting in generation of an unwrapped all-in-focus phase map 635 (e.g., as described with respect to block 235). Then, the unwrapped all-in-focus phase map 635 may be used to reconstruct a 3D point cloud 640 with a large DOF (e.g., as described with respect to block 240).

### Experimental Data

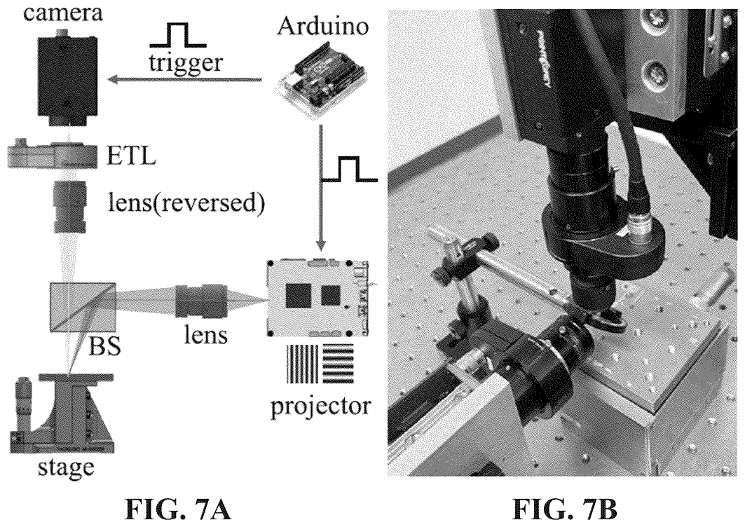

Described below are experimental setups and validations of the disclosed system and methodology. An example prototype system was built, as shown in FIGS. 7A and 7B. The system consisted of a camera (model: PointGrey GS3-U3-23S6M) branch and a projector (model: Shanghai Yiyi D4500) branch. The camera branch was equipped with a 35 mm fixed aperture (f/1.6) lens (model: Edmund Optics #85-362) which was mounted reversely to increase image distance, an equivalent 20 mm extension tube, a circular polarizer (model: Edmund Optics CP42HE), and an ETL (model: Optotune EL-16-40-T^{c}). The projector branch was equipped with a 35 mm lens (model: Fujinon HF35HA-1B), a circular polarizer (model: Edmund Optics CP42HE), and an ETL (model: Optotune EL-16-40-T^{c}). Each ETL was tuned by a lens driver controller (model: Optotune Lens Driver 4i). A beam splitter (model: Thorlabs BP145B1) was used to adjust the projector light path.

In the following example experiments, the camera resolution was set as 1536×1140 pixels and the projector resolution as 912×1140 pixels. Eleven different focus settings produced by ETL currents ranging from −146.00 mA to −116.00 mA with an interval of 3.00 mA were used to capture the focal stack images. The projector ETL was held at 20.74 mA during the process to ensure the common focus range with the camera. The aperture of the projector lens was set as f/5.6. Three phase-shifted fringe patterns for each focus setting were captured with a period of 18 pixels, and set the weight in the energy minimization algorithm (described above) as 0.35 (i.e., λ=0.35).

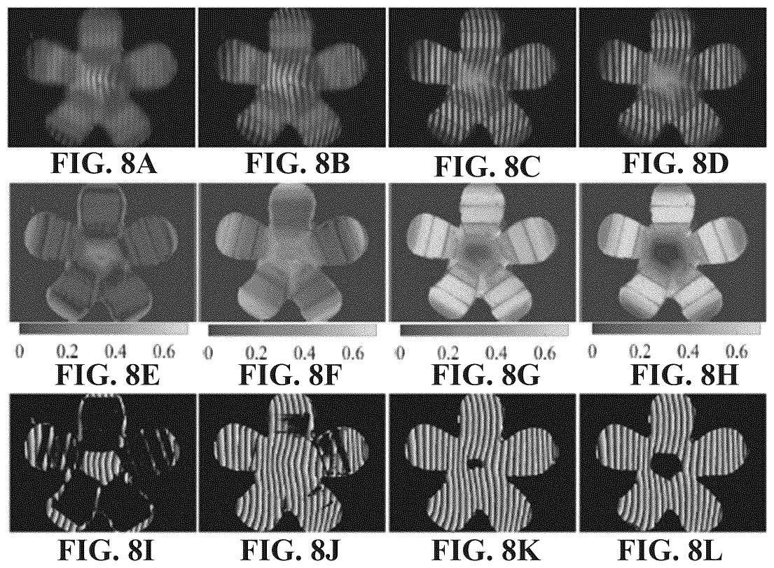

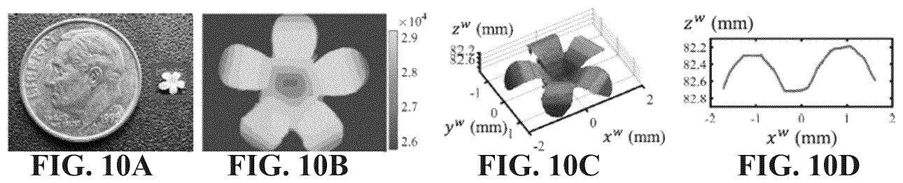

The disclosed techniques were evaluated by measuring a 3D-printed sample with a height of approximately 600 m, as shown in FIG. 10A. Three phase-shifted patterns were captured under each focus setting. FIGS. 8A-8D show four representative fringe images when the ETL current was set as −146.00 mA, −140.00 mA, −134.00 mA, and −131.00 mA, respectively. The corresponding fringe contrast maps were computed, which are shown in FIGS. 8E-8H, and the wrapped phase maps that are shown in FIGS. 8I-8L were generated using the phase-shifting algorithm described above (e.g., with respect to block 205 of FIG. 2). In this step, the pixels with fringe contrast values below 0.1 or with averaged intensity values below 30 were masked out.

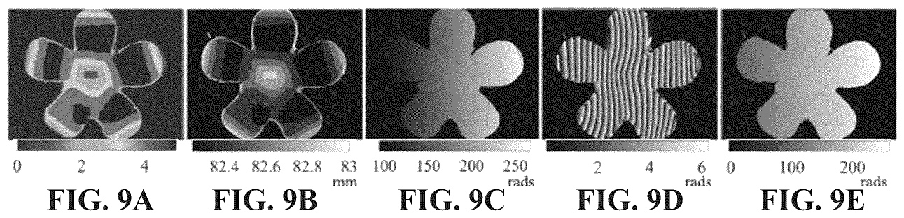

FIGS. 9A-9E illustrate creation of unwrapped phase for the example shown in FIGS. 8A-8L. More particularly, FIG. 9A shows a label map generated using the fringe contrast maps. The label map was computed from all fringe contrast maps using the techniques described with respect to block 215. The calibrated relationship between the focal plane position and the ETL current discussed herein was adopted to compute the rough depth map, which is shown in FIG. 9B. The artificial phase map, shown in FIG. 9C, was computed using the rough depth map and the corresponding calibration data and label map shown in FIG. 9A. The label map was used to extract the phase value of the most in-focus pixels to form an in-focus wrapped phase map. FIG. 9D shows the in-focus wrapped phase. The in-focus wrapped phase map was unwrapped by the artificial phase map to create the unwrapped in-focus phase map, as shown in FIG. 9E.

The unwrapped in-focus phase map, shown in FIG. 9E, was further processed to reconstruct a 3D point cloud using the label map and the corresponding calibration data. FIGS. 10A-10D illustrate this 3D reconstruction of the corresponding unwrapped phase map shown in FIG. 9E. More particularly, FIG. 10A shows a photograph of the sample (red windowed) compared to a U.S. dime. FIG. 10B shows one of the intrinsic parameters

$$( i . e . , {f}_{u}^{c} )$$

that was used to process each pixel. FIG. 10C shows the reconstructed 3D point cloud. FIG. 10D shows a cross section of the reconstructed 3D data. This experimental result indicates that the disclosed techniques can be used to create an in-focus phase map for 3D measurement.

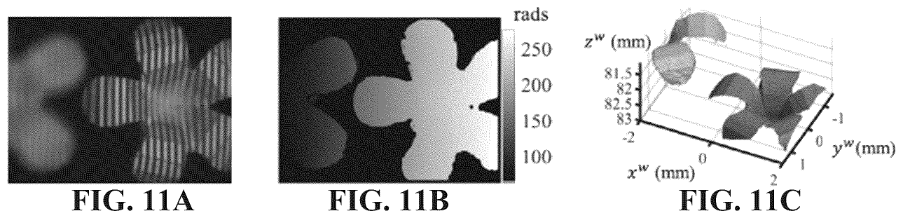

Another scene was measured with an approximately 2 mm depth range to evaluate the performance of the proposed phase unwrapping method for two isolated objects (two identical samples shown in FIG. 10A) with a large depth range (approximately 2 mm). Fringe images were captured under the same number of focal planes used in the previous example, shown in FIGS. 8A-8L, FIGS. 9A-9E, and FIGS. 10A-10D. FIG. 11A shows one of the captured fringe images when the ETL current was set as −137.00 mA. As shown in FIG. 11A, these two identical samples were positioned at different depths such that one single focus setting is insufficient to focus on both samples at the same time. The disclosed techniques were then applied to all fringe images captured at different focus settings to create an in-focus unwrapped phase map, shown in FIG. 11B. The unwrapped phase map was then used to reconstruct the 3D shape of the scene. FIG. 11C shows the final reconstructed 3D point cloud, indicating that both samples are properly reconstructed. This experiment demonstrated that the disclosed techniques achieved a large DOF (approximately 2 mm) even though only three-step phase-shifted patterns were used for each focus setting.

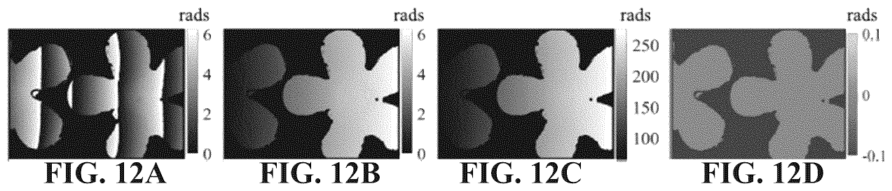

In addition, the results of the disclosed techniques were compared with the existing three-frequency phase unwrapping algorithm. Two more sets of three phase-shifted patterns were projected and captured, two with one fringe period being 144 pixels and the other fringe period being 912 pixels for each focus setting. Then, an in-focus wrapped phase map was created for each fringe period. FIG. 12A shows the in-focus phase map when the fringe period is 144 pixels, and FIG. 12B shows the in-focus phase map when the fringe period is 912 pixels. The traditional three-frequency phase unwrapping algorithm was then employed to create the in-focus unwrapped phase map, shown in FIG. 12C. A difference map was made by subtracting the unwrapped phase map shown in FIG. 11C generated with the disclosed techniques from the one shown in FIG. 12C. FIG. 12D shows the difference map, which is zero for all valid pixels. This experimental result further confirmed that the proposed method produced an identical unwrapped phase map comparing the traditional three-frequency phase unwrapping algorithm, albeit without using additional fringe patterns with different fringe periods.

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term and “substantially” and “significantly” will mean more than plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

Various embodiments, configurations, materials, devices, systems, methods, and techniques are disclosed herein. With respect to the devices and systems described above, certain alternative components and materials are described, none of which are intended to be limiting or required. The description of components of such devices and systems is intended to be illustrative only, and neither a minimum nor limit of the types of components that could be used in various embodiments hereof. Similarly, the methods described herein are explained with reference to optional steps and modifications, none of which are intended to be limiting or required. The methods described herein can be performed using hardware such as (or including) the devices and systems described herein but need not be implemented through such hardware except in specific examples that identify the use of such hardware.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A three-dimensional imaging microscope system, the system comprising:
a projector;
a camera;
an electrically tunable lens (ETL); and
a processor coupled to the projector, the camera, and the ETL, wherein the processor is configured to:
capture, using the camera, a plurality of phase-shifted images of a sample by controlling the projector, the camera, and the ETL;
generate a plurality of fringe contrast maps based on the plurality of phase-shifted images, wherein each fringe contrast map of the plurality of fringe contrast maps corresponds to a respective focus setting of a plurality of focus settings of the ETL;
generate a label map based on the plurality of fringe contrast maps;
extract a plurality of in-focus pixels from the plurality of phase-shifted images to generate a wrapped in-focus phase map;
generate, based on the label map, a rough depth map indicating an estimated depth for each pixel of the plurality of in-focus pixels;
generate, based on the rough depth map, an artificial phase map;
unwrap the wrapped in-focus phase map to generate an unwrapped in-focus phase map; and
generate a three-dimensional point cloud based on the unwrapped in-focus phase map.

2. The system of claim 1, wherein the plurality of phase-shifted images is captured by changing a focus setting of the ETL to the plurality of focus settings using a plurality of current levels.

3. The system of claim 1, wherein, to generate the label map, the processor is to:
identify, for each pixel of the label map, a fringe contrast map of the plurality of fringe contrast maps based on contrast levels for corresponding pixels within the plurality of fringe contrast maps that correspond to the pixel of the label map.

4. The system of claim 1, wherein, to generate the plurality of fringe contrast maps based on the plurality of phase-shifted images, the processor is to:
generate a plurality of wrapped phase maps from the plurality of phase-shifted images, wherein each wrapped phase map corresponds to a respective contrast fringe map of the plurality of fringe contrast maps, and wherein each wrapped phase map is generated from a respective set of phase-shifted images of the plurality of phase-shifted images that were captured with the focus setting for the corresponding contrast fringe map.

5. The system of claim 4, wherein, to generate the wrapped in-focus phase map, the processor is to:
extract in-focus pixels from the plurality of wrapped phase maps as indicated by the label map; and
combine the in-focus pixels extracted from the plurality of wrapped phase maps to form the wrapped in-focus phase map.

6. The system of claim 1, further comprising:
a beam splitter;
a stage for supporting the sample;
a first lens positioned between the beam splitter and the ETL; and
a second lens positioned between the beam splitter and the projector.

7. The system of claim 1, wherein the artificial phase map is generated based on a calibrated multi-focus pin-hole model.

8. A method, the method comprising:
capturing, using a camera, a plurality of phase-shifted images of a sample by controlling a projector, a camera, and an electrically tunable lens (ETL) via a processor;
generating a plurality of fringe contrast maps based on the plurality of phase-shifted images, wherein each fringe contrast map of the plurality of fringe contrast maps corresponds to a respective focus setting of a plurality of focus settings of the ETL;
generating a label map based on the plurality of fringe contrast maps;
extracting a plurality of in-focus pixels from the plurality of phase-shifted images to generate a wrapped in-focus phase map;
generating, based on the label map, a rough depth map indicating an estimated depth for each pixel of the plurality of in-focus pixels;
generating, based on the rough depth map, an artificial phase map;
unwrapping the wrapped in-focus phase map to generate an unwrapped in-focus phase map; and
generating a three-dimensional point cloud based on the unwrapped in-focus phase map.

9. The method of claim 8, wherein capturing the plurality of phase-shifted images includes:
changing a focus setting of the ETL to the plurality of focus setting using a plurality of current levels, and
capturing a set of phase-shifted images of the plurality of phase-shifted images at each focus setting of the plurality of focus setting.

10. The method of claim 8, wherein generating the label map includes:
identifying, for each pixel of the label map, a fringe contrast map of the plurality of fringe contrast maps having a highest contrast level of corresponding pixels within the plurality of fringe contrast maps that correspond to the pixel of the label map.

11. The method of claim 8, wherein generating the plurality of fringe contrast maps based on the plurality of phase-shifted images includes:
generate a plurality of wrapped phase maps from the plurality of phase-shifted images, wherein each wrapped phase map corresponds to a respective contrast fringe map of the plurality of fringe contrast maps, and wherein each wrapped phase map is generated from a respective set of phase-shifted images of the plurality of phase-shifted images that were captured with the focus setting for the corresponding contrast fringe map.

12. The method of claim 11, wherein generating the wrapped in-focus phase map includes:
extracting in-focus pixels from the plurality of wrapped phase maps as indicated by the label map; and
combining the in-focus pixels extracted from the plurality of wrapped phase maps to form the wrapped in-focus phase map.

13. The method of claim 8, further comprising:
projecting, via the projector, a pattern into a first lens positioned between a beam splitter and a stage supporting the sample,
wherein a reflected pattern is directed into the camera via a second lens positioned between the ETL and the beam splitter.

14. The method of claim 8, wherein the artificial phase map is generated based on a calibrated multi-focus pin-hole model.

15. A non-transitory computer readable medium storing instructions that, when executed, cause a processor to:
capture, using a camera, a plurality of phase-shifted images of a sample by controlling a projector, a camera, and an electrically tunable lens (ETL) via the processor;
generate a plurality of fringe contrast maps based on the plurality of phase-shifted images, wherein each fringe contrast map of the plurality of fringe contrast maps corresponds to respective focus setting of a plurality of focus settings of the ETL;
generate a label map based on the plurality of fringe contrast maps;
extract a plurality of in-focus pixels from the plurality of phase-shifted images to generate a wrapped in-focus phase map;
generate, based on the label map, a rough depth map indicating an estimated depth for each pixel of the plurality of in-focus pixels;
generate, based on the rough depth map, an artificial phase map;
unwrap the wrapped in-focus phase map to generate an unwrapped in-focus phase map; and
generate a three-dimensional point cloud based on the unwrapped in-focus phase map.

16. The non-transitory computer readable medium of claim 15, wherein the plurality of phase-shifted images is captured by changing a focus setting of the ETL to the plurality of focus settings using a plurality of current levels.

17. The non-transitory computer readable medium of claim 15, wherein, to generate the label map, the instructions cause the processor to:
identify, for each pixel of the label map, a fringe contrast map of the plurality of fringe contrast maps having a highest contrast level of corresponding pixels within the plurality of fringe contrast maps that correspond to the pixel of the label map.

18. The non-transitory computer readable medium of claim 15, further comprising instructions that, when executed, cause the processor to:
generate a plurality of wrapped phase maps from the plurality of phase-shifted images, wherein each wrapped phase map corresponds to a respective contrast fringe map of the plurality of fringe contrast maps, and wherein each wrapped phase map is generated from a respective set of phase-shifted images of the plurality of phase-shifted images that were captured with the focus setting for the corresponding contrast fringe map.

19. The non-transitory computer readable medium of claim 18, wherein, to generate the wrapped in-focus phase map, the instructions cause the processor to:
extract in-focus pixels from the plurality of wrapped phase maps as indicated by the label map; and
combine the in-focus pixels extracted from the plurality of wrapped phase maps to form the wrapped in-focus phase map.

20. The non-transitory computer readable medium of claim 15, further comprising instructions that, when executed, cause the processor to:
project, via the projector, a pattern into a first lens positioned between a beam splitter and a stage supporting the sample,
wherein a reflected pattern is directed into the camera via a second lens positioned between the ETL and the beam splitter.
